(19) United States
(12) Patent Application Publication
(10) Pub. No.: US 2006/0172098 A1
(43) Pub. Date: Aug. 3, 2006

(54) Retortable/peelable film

(75) Inventor: James A. Stevenson, Pittsburgh, PA (US)

Correspondence Address: GREENBERG TRAURIG LLP, 2450 COLORADO AVENUE, SUITE 400E, SANTA MONICA, CA, 90404, US

(73) Assignee: ALCOA, INC., Pittsburgh, PA (US)

(21) Appl. No.: 11/398,388

(22) Filed: Apr. 4, 2006

Related U.S. Application Data
(63) Continuation-in-part of application No. 10/388,001, filed on Mar. 12, 2003.

(51) Int. Cl. B32B 27/08

(52) U.S. Cl. 428/35.7

(57) ABSTRACT

A material suitable for sealing plastic containers and used as a lid on a container for food is disclosed. The material comprises a substrate joined to a film comprising a mixture of a butene-1 polymer, polypropylene, an organic filler, and, optionally, high density polyethylene. The material is heat sealable, peelable and retains high burst strength both during and after retorting at elevated temperatures.

### RELATED APPLICATION DATA

This application is a Continuation-in-part of U.S. patent application Ser. No. 10/388,001, filed Mar. 12, 2003 entitled LIDSTOCK MATERIAL HAVING IMPROVED BURST STRENGTH hereby incorporated by reference in its entirety.

### BACKGROUND

1. Field

The present disclosure relates to a lidstock material suitable for making lids to be sealed over plastic containers such as food containers.

2. Background

Many products are placed in containers covered by a peelable lidstock material and such products can range from low acid food and soups to disposable contact lenses. Such lidstocks must be sealable to polypropylene containers and polypropylene coated metal ends, peelable and resistant to both hot and cold temperatures.

The lid covering the container is heat sealed over the recess containing the products. Then the package is retorted in an autoclave to sterilize the contents. A lidstock material for the lid must possess sufficient burst strength during and after autoclaving to keep the package sealed so that the products inside do not escape when autoclaved or during the shelf life of the container. The lid must also be cleanly peelable from the container in order to provide easy access to the product held within the container.

Lidstock materials suitable for covering openings in packages for contact lenses and foods are known in the prior art. However, the prior art lidstock materials generally suffer from one or more serious disadvantages making them less than entirely satisfactory for their intended purpose.

Prior formulations of various lidstock materials include the lidstock material disclosed in the parent patent application referenced above, comprising a mixture of butene-1 polymer, high density polyethylene, an inorganic filler and polypropylene laminated to a metal foil or polymer substrate. The prior formulation works well with applications designed for contact lens blisters wherein a high manufacturing temperature with controlled overpressure is used to ensure sterilization. However, various prior art formulations of lidstock material do not work as well for retorting in food processing where high temperatures are used but overpressures are not well controlled and can vary widely.

The present disclosure provides a lidstock material with improved burst strength for making heat sealable and peelable lids on plastic containers where higher seal integrity, or burst strength, is required during retorting (at elevated temperatures).

Additional objectives and advantages of the present disclosure will become apparent from the following detailed description.

### SUMMARY

In accordance with the present disclosure there is provided a peelable and heat-sealable lidstock material suitable for making lids for plastic containers. Plastic containers sealed by lids made in accordance with the invention are used for not only holding disposable contact lenses, but are also suitable for holding foods such as beef, lamb, pork, poultry, stews, soups, and pet foods, that are sterilized by retorting after being sealed in their containers.

As used herein, the term “lidstock material” refers to a metal, polymer, or paper substrate laminated with a heat seal layer or film. Lidstock material of the present disclosure is made into container lids by cutting or stamping the material into desired shapes such as rectangles. As used herein, the term “heat sealable” refers to the ability to form a bond between a plastic container and its lid when heat and pressure are applied locally for a sufficient time. The bond is gas-tight and preferably has sufficient burst strength to resist separation of the lid from the container body, even when the sealed container is retorted at an elevated temperature.

As used herein, the term “peelable” refers to the ability of a sealed lid to separate (i.e., release) from sealed engagement with a container body while both the lid and the body substantially retain their integrity. Such separation and release are achieved by manually applying a separating force to an outer edge portion of the lid. The lidstock material of the present disclosure in exemplary embodiments is a substrate laminated with a film comprising a polymer mixture. The substrate in one embodiment is an aluminum foil having a thickness of about 0.25 mil to 4.0 mils (0.00025 inch to 0.004 inch). Aluminum foil provides an excellent barrier against penetration of gases and moisture. Aluminum foil also protects the package contents from ultraviolet light and has an aesthetically pleasing appearance. A particular embodiment includes an aluminum foil substrate having a thickness of about 2.0 mils (0.002 inch). In other exemplary embodiment, suitable materials for the substrate include biaxially oriented polyethylene terephthalate (PET), nylon, and combinations thereof.

The film in the lidstock material comprises a co-extruded film having two layers. In one embodiment, the sealing layer has a formulation of a butene-1 polymer, polypropylene, and a particulate inorganic filler. In alternative embodiments, high density polyethylene is also included in the formulation of the sealing layer.

The film also includes a carrier layer. In particular embodiments, the carrier layer comprises polypropylene.

Some suitable inorganic fillers include talc, amorphous silica and alumina trihydrate. The filler enhances peelablity of the coating by assisting in shifting seal failure upon peeling from adhesive failure at the container-coating layer interface to cohesive failure within the coating layer itself. The filler comprises at least about 18 wt. % of the coating, preferably about 20-40 wt. %, more preferably about 20-30 wt. % and optimally about 25 wt. %. The filler is preferably a powder having an average particle size of about 0.5-10 microns. Talc having an average particle size of about 1-2 microns is particularly preferred. The talc should be provided with a surface coating comprising about 0.5-5 wt. % of the filler, preferably about 1 wt. %. A carboxylic acid surface coating is particularly preferred.

The aluminum foil substrate is coated with a print primer in exemplary embodiments. The print primer facilitates application of printed labeling on the substrate. A particularly preferred print primer has a coating weight of about 0.7 pounds per 3000 square feet.

In some embodiments, the lidstock material is used as a lid for a plastic container.

In other embodiments, a container having a body with an edge defining an opening and a flange extending radially outward from the opening has a lid. The lid comprising the heat sealable and peelable material heat is sealed to the flange.

In another aspect of the disclosed lidstock, the material has improved burst strength for making heat sealable and peelable lids on plastic containers where higher seal integrity, or burst strength, is required during retorting. In particular embodiments, the burst strength of the material is between about 38-48 pounds per square inch at 250° F. In other embodiments, the burst strength of the lidstock is about 3040 pounds per square inch at 270° F.

### DRAWINGS

FIG. 1 is a top plan view of a blister pack made in accordance with the disclosed retortable film;

FIG. 2 is a side elevational view of the blister pack of FIG. 1 with the lid partially peeled back;

FIG. 3 is an enlarged fragmentary, cross-sectional view of the lid of the blister pack shown in FIG. 2, and

FIG. 4 is a perspective view of a food container which might be made with the disclosed retortable film.

### DETAILED DESCRIPTION

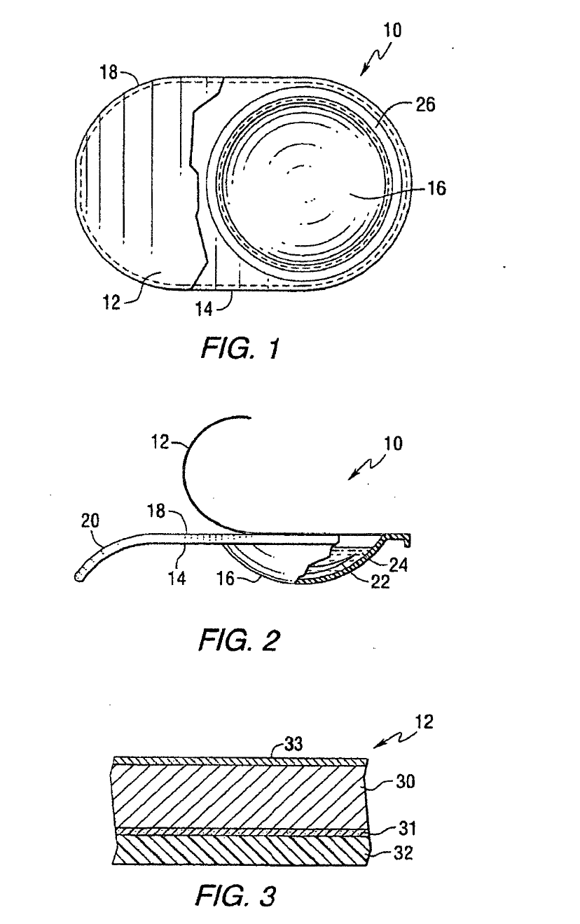

In FIGS. 1 and 2 there is shown one type of many varieties of containers that are useful with the lidstock material of this invention; a blister pack 10 made in accordance with the present invention, with a lid 12 partially peeled back to reveal its contents. While the present invention will be described with a blister pack this is in no way to be taken as limiting. The pack 10 comprises an injection molded plastic container body 14 heat sealed to the lid 12. The body 14 defines a bowl-shaped recess 16 having a diameter of about 2 cm. and a depth of about 0.5 cm. A flange 18 extending around the recess 16 includes a tapered curled lip 20 spaced apart from the recess 16.

The recess 16 here houses a contact lens 22 and a saline solution 24. The recess 16 is circumscribed by a seal area 26 which is part of the flange 18. The lid 12 is preferably attached to the body 14 by heat sealing in the seal area 26. Other suitable means for attaching the lid 12 to the body 14 include induction sealing and sonic welding. The total interior volume defined by the recess 16 and the lid 12 is preferably less than 1 milliliter. The body 14 is preferably made from a plastic material which can be shaped by injection molding or thermoforming.

The plastic material for the body is preferably polypropylene but may also be other plastic materials having similar properties, such as polyethylene, polyethylene-polypropylene mixtures, polyethylene-polypropylene copolymers, polybutylene, polyesters (e.g. PET), polycarbonates, and other thermoplastics. Plastics having low vapor transmission rates are most preferred.

Referring now to FIG. 3, the lid 12 is made from lidstock material comprising substrate 30, preferably aluminum foil, having a polyurethane adhesive layer 31 joining a film 32 to the substrate 30. An exterior side of the substrate 30 displays graphic matter (not shown) printed over a print primer 33. The substrate 30 has a thickness of about 2 mils. (0.002 inch-50.8 micrometers). The print primer 33 has a weight of about 0.4 to 0.9 pounds per 3000 square feet. The film 32 has a thickness of about 25 micrometers (1 mil.), corresponding to a weight of about 17 pounds per 3000 square feet. The lid 12 includes only a single layer of the film 32.

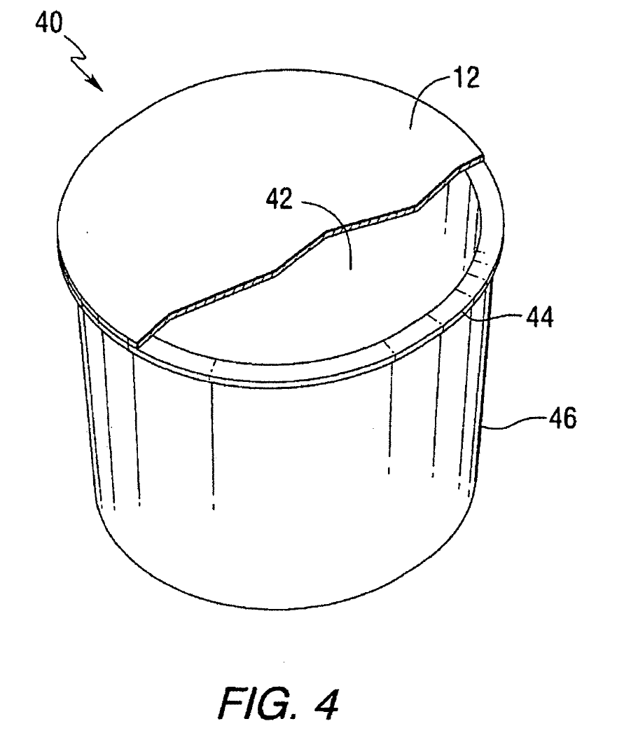

FIG. 4 shows another type of container that might use the lidstock material of the present disclosure. The container 40 has a cavity 42 for containing food. The cavity 42 can contain different food products, including examples such as soups, stews, meats and pet food as well as many other foods. The container 40 comprises a flange 44 extending radially outward from the body 46 and a lid 12 made from the lidstock material having the same configuration of FIG. 3.

The film 32 is a co-extruded film having two layers. The two layers include a sealing layer and a carrier layer. The sealing layer has a thickness of about 0.0007

In one exemplary embodiment, the sealing layer of the film comprises polybutene-1, polypropylene and organic filler. In a particular embodiment, the organic filler is talc. In other embodiments, the organic filler could also be talc, amorphous silica, alumina trihydrate, and mixtures thereof. The following table illustrates the compositions of these components for this exemplary film.

TABLE 1
Exemplary Composition A

| Ingredient | Range Weight % |
|---|---|
| Butene-1 Polymer | 10 to 20 |
| Particulate Organic Filler | 20 to 30 |
| Polypropylene | 50 to 65 |

In another embodiment, the sealing layer includes high density polyethylene as well as poly-butene-1, polypropylene and organic filler. Table 2 illustrates the compositions of these components for this embodiment.

TABLE 2
Exemplary Composition B

| Ingredient | Range Weight % |
|---|---|
| Butene-1 Polymer | 5 to 20 |
| Particulate Organic Filler | 20 to 30 |
| Polypropylene | 35 to 50 |
| High Density Polyethylene | 20 to 30 |

The carrier layer of the film comprises 100% polypropylene.

Tests performed on the new film compositions show that the film compositions of the present disclosure have increased burst strength under higher environmental (retort) temperatures compared to previous film compositions comprising about 15 to 25% of a butene-1 polymer, about 35 to 55% of high density polyethylene, about 5-15%. The following table compares the burst strength of two film compositions of the present disclosure to prior art compositions.

TABLE 3
Comparison of Burst Strength

| | Burst Strength | Burst Strength |
|---|---|---|
| Material | at 250 F. | at 270 F. |
| Previous Composition | 26 psi | 14 psi |
| Exemplary Composition 1 | 45 psi | 37 psi |
| Exemplary Composition 2 | 41 psi | 33 psi |

Containers made in accordance with the foregoing examples have excellent burst strength, both during the sterilization process and after the packages are sterilized. The lidstock materials are impermeable to bacteria so that the contents are preserved, have a negligible vapor transmission rate to avoid loss of water, have the ability to maintain the contents in original condition increasing the shelf life of the product, and low variation in peel strength over an expected range of heat seal temperatures.

Additionally, the lidstock made in accordance with the foregoing examples has a peel with a very cohesive nature. Peelablity is the ability of a sealed lid to separate and to release from sealed engagement with a container body while both the lid and the body substantially retain their integrity. Such separation and release are achieved by manually applying a separating force to an outer edge portion of the lid.

Use of the filler in the sealing layer enhances peelablity of the coating by helping shift seal failure upon peeling from adhesive failure at the container-coating layer interface to cohesive failure in the coating layer itself. In an exemplary embodiment, the lidstock breaks away from itself and leaves a clean layer of film on the container surface.

While the above description contains many particulars, these should not be considered limitations on the scope of the disclosure, but rather a demonstration of embodiments thereof. The lidstock material and uses disclosed herein include any combination of the different species or embodiments disclosed. Accordingly, it is not intended that the scope of the disclosure in any way be limited by the above description. The various elements of the claims and claims themselves may be combined any combination, in accordance with the teachings of the present disclosure, which includes the claims.

1. A peelable and heat sealable material for bonding to a polypropylene and polypropylene coated substrates, comprising a solid substrate joined to a film, the film comprising:
a sealing layer, the sealing layer including about 20-30 weight % of a particulate inorganic filler; about 5-20 weight % of a butene-1 polymer; and about 35-65 weight % of polypropylene; and
a carrier layer, the carrier layer including polypropylene.

2. The material of claim 1 wherein the sealing layer further comprises about 20-30 weight % of a high density ethylene polymer.

3. The material of claim 1 wherein the substrate material is a lidstock material and comprises at least one material selected from metal, foil, and paper.

4. The material of claim 1 wherein the inorganic material comprises talc, silica, or alumina.

5. The material of claim 1 wherein the substrate material is a lidstock material and comprises aluminum foil.

6. The material of claim 1 wherein said sealing layer comprises about 15 weight % of a butene-1 polymer.

7. The material of claim 1 wherein said sealing layer comprises about 60 weight % of polypropylene.

8. The material of claim 1 wherein said sealing layer comprises about 25 weight percent of inorganic filler.

9. The material of claim 8 wherein said inorganic filler comprises talc.

10. The material of claim 2 wherein said sealing layer comprises about 10 weight % of a butene-1 polymer.

11. The material of claim 2 wherein said sealing layer comprises about 40 weight % of polypropylene.

12. The material of claim 2 wherein said sealing layer comprises about 25 weight percent of inorganic filler.

13. The material of claim 12 wherein said inorganic filler comprises talc.

14. The material of claim 2 wherein said sealing layer comprises about 25 weight % of high density polypropyelene.

15. The material of claim 1 wherein said material is peelable and heat sealable.

16. The material of claim 1 wherein said material has a burst strength of about between 38-48 pounds per square inch at 250° F.

17. The material of claim 1 wherein said material has a burst strength of about between 30-40 pounds per square inch at about 270° F.

18. A lid for a plastic container comprising a peelable and heat sealable material having a solid substrate joined to a film, the film comprising:
a sealing layer, the sealing layer including about 20-30 weight % of a particulate inorganic filler; about 5-20 weight % of a butene-1 polymer; and about 35-65 weight % of polypropylene; and
a carrier layer, the carrier layer including polypropylene.

19. The lid of claim 18 wherein the sealing layer further comprises about 20-30 weight % of a high density ethylene polymer.

20. A container comprising a body having an edge defining an opening and a flange extending radially outwardly of said opening, and a lid comprising the lidstock a peelable and heat sealable material having a solid substrate joined to a film, the lid heat sealed to the flange, the film comprising:
a sealing layer, the sealing layer including about 20-30 weight % of a particulate inorganic filler; about 5-20 weight % of a butene-1 polymer; and about 35-65 weight % of polypropylene; and
a carrier layer, the carrier layer including polypropylene.

21. The lid of claim 20 wherein the sealing layer further comprises about 20-30 weight % of a high density ethylene polymer.
